(19) United States
(12) Patent Application Publication
(10) Pub. No.: US 2013/0298727 A1
(43) Pub. Date: Nov. 14, 2013

(54) AUTOMATIC CYCLE PEDAL WITH SUPPORT CAGE

(71) Applicant: LOOK CYCLE INTERNATIONAL, Nevers (FR)

(72) Inventors: Victor EGEA, NEVERS (FR); Fabien DELANGUE, VARENNES VAUZELLES (FR)

(73) Assignee: LOOK CYCLE INTERNATIONAL, NEVERS (FR)

(21) Appl. No.: 13/890,695

(22) Filed: May 9, 2013

(30) Foreign Application Priority Data
May 10, 2012 (FR) 12 54276

(51) Int. Cl. B62M 3/08

(52) U.S. Cl. CPC B62M 3/086
USPC 74/594.6

(57) ABSTRACT

The automatic cycle pedal includes a pedal body (2) mounted to rotate on a pedal axis (3) and provided with a front member (5) for engaging an attachment member fixed under the sole of a shoe of a cyclist, and a rear member (6) for retaining the attachment member. The automatic pedal (1) also includes primary support surfaces (8) provided on the pedal body (2) and used simultaneously with auxiliary support surfaces (10) provided on a support cage (9) arranged around the pedal body (2) while giving access to the front and rear members (5, 6). The support cage (9) is mounted removably on the pedal body (2) using link elements (11) so as to allow the automatic pedal with support cage with auxiliary support surfaces to be converted into an ordinary automatic pedal without support cage and vice versa.

### BACKGROUND OF THE INVENTION

The present invention relates to an automatic cycle pedal that makes it possible to securely attach a shoe of a cyclist against an attachment face provided on the pedal. This automatic pedal is provided with a support cage having auxiliary support surfaces around a pedal body having primary support surfaces. Such an automatic pedal is known from the publication EP1338501 which describes an automatic pedal with support cage and with four attachment faces, that is to say at 90° to one another.

It should be noted that the support cage gives free access to retaining means provided on the pedal body so as to allow the function of the pedal in automatic attachment mode. The primary support surfaces provided on the pedal body and the secondary support surfaces provided on the support cage are thus used simultaneously.

The idea of “automatic” is linked to the fact that the shoe bears an attachment member or retaining chock in the form of a plate fixed under the sole of the shoe of the cyclist and intended to trigger a hands-free fastening by quite simply stressing this chock against the retaining means provided on the pedal. The latter are linked to the pedal body which is mounted to rotate on a pedal axis which can be linked to a crankset crankarm. They generally comprise a front member for engaging the chock and a rear retaining member which can be elastically toggled between a position releasing the chock and a position retaining the latter against an attachment face on the pedal body.

### DESCRIPTION OF THE PRIOR ART

In the automatic pedal according to the publication EP1338501, the front member engaging the chock and the rear member retaining the chock consist of hoops made of metal wire. Originally, a pedal of this kind comprises only relatively limited primary support surfaces for the sole on the pedal body. This is why, according to EP1338501, a support cage provided with auxiliary support surfaces is arranged around the pedal body.

The advantages of the automatic pedals provided with a support cage are thus the addition of a greater support surface area by virtue of the support cage, as well as a possibility for the cyclist not to be required to put the shoes back on again in a technical stage during a race where he or she had inadvertently taken the shoes off.

The invention is intended to be applied to an automatic pedal with hoops, but also to an automatic pedal with lever forming the retaining mobile rear member. Generally, this type of automatic pedal comprises only a single face for attaching a chock.

One drawback with an automatic pedal with support cage is that it inevitably weighs more than an automatic pedal without support cage. It should be noted that the support cage according to the publication EP1338501 is mounted in a non-removable manner on the pedal body.

Consequently, the major drawback lies in the fact that the manufacturer who wants to offer both automatic pedals without support cage and automatic pedals with support cage is obliged to develop two distinct product ranges, which leads to additional production costs.

Another consequence of this for the consumer is that he or she is obliged to buy two different products to have the advantages of pedals with and without support cage.

Consequently, there is a definite need both with the manufacturer and with the consumer to have an automatic pedal which combines the advantages of both the ranges of automatic pedals, that is to say with and without support cage.

The aim of the invention is to propose an automatic pedal which can allow an automatic pedal with support cage to be converted, still operating as automatic pedal, into an ordinary automatic pedal without support cage and vice versa in order to thus satisfy the needs of the manufacturer and of its customers.

### SUMMARY OF THE INVENTION

The subject of the invention is an automatic cycle pedal with support case, comprising a pedal body mounted to rotate on a pedal axis, said pedal body being provided with a front member that can engage an attachment member fixed under the sole of a shoe of a cyclist, and a rear member that can retain said attachment member, the automatic pedal also comprising primary support surfaces provided on the pedal body and intended to be used simultaneously with auxiliary support surfaces provided on a support cage arranged around the pedal body while giving access to said front and rear members of the pedal body, wherein said support cage is mounted removably on the pedal body so as to allow the automatic pedal with support cage with auxiliary support surfaces to be converted into an ordinary automatic pedal without support cage with auxiliary support surfaces and vice versa.

According to other features of the invention:

the support cage is of a single-sided single piece arranged on one of the attachment faces of the pedal, the pedal body comprising link means capable of cooperating with link means provided on the support cage, and the other face of the pedal is free of auxiliary support surfaces;

the support cage is formed by a first part and a second part provided with said auxiliary support surfaces and comprising link means making it possible to link them to one another so as to present auxiliary support surfaces on two opposing attachment faces of the automatic pedal;

said first part and said second part of the support cage are single-sided and linked to one another so as to sandwich the pedal body;

said first and second parts of the support cage are double-sided and complementary to one another by being arranged symmetrically in front of and behind the pedal body, said first and second parts respectively comprising a complementary lateral void defining a housing for receiving the pedal body when said first and second parts of the support cage are linked to one another along a joining plane passing through the central axis of the pedal axis; and

said first and second parts of the support cage are double-sided, said first part of said support cage is permanently linked to the pedal body on an internal side thereof, said second part is complementary to said first part and linked thereto along a joining plane at right angles to the central axis of the axis of the pedal, and said second part comprises a central through-hole defining a housing for receiving the pedal body.

Another subject of the invention is a removable support cage with auxiliary support surfaces for an automatic cycle pedal having the features mentioned above.

Yet another subject of the invention is a set of removable support cages with auxiliary support surfaces for an automatic cycle pedal comprising a number of support cages according to the invention.

### BRIEF DESCRIPTION OF THE DRAWINGS

Other features and advantages of the invention will emerge from the following description of a number of non limiting embodiments of the invention, with reference to the appended figures in which:

FIG. 1 is a perspective view of an automatic pedal which can receive a support cage according to the invention;

FIGS. 2A and 2B are respectively plan and perspective views of a single-sided removable support cage according to the invention;

FIG. 3 is a perspective view showing a cage in place under the pedal body of an automatic pedal;

FIG. 4 is an end view of the assembly shown in FIG. 3,

FIG. 5 is an end view similar to that of FIG. 4, with two support cage parts linked to one another around the pedal body;

FIG. 6 is a perspective view of the assembly of FIG. 5;

FIGS. 7 and 8 are respectively plan and perspective views showing a first and a second double-sided support cage part linked to one another along a joining plane which passes through the central axis of the pedal body;

FIGS. 9 and 10 are respectively plan and perspective views showing a first and a second double-sided support cage part linked to one another along a joining plane at right angles to the central axis A-A of the pedal axis; and

FIG. 11 is a perspective view of an automatic pedal with lever and single-sided which can receive a support cage according to the invention; and

FIG. 12 is a plan view showing the automatic pedal of FIG. 11 provided with two support cage parts linked to one another sandwiching the pedal body.

In the figures, the elements that are identical or equivalent bear the same reference signs.

### DESCRIPTION OF THE PREFERRED EMBODIMENTS

The operation of an automatic pedal will not be described here. For more details, see for example EP1780113 from the applicant. With regard to the shoes of the cyclists, they are adapted to bear a fixing chock which is fixed either to the sole of the shoe when the chock is large, or in a void in the sole when the chock is small. For more details, see for example EP1502515 from the applicant which illustrates the latter case.

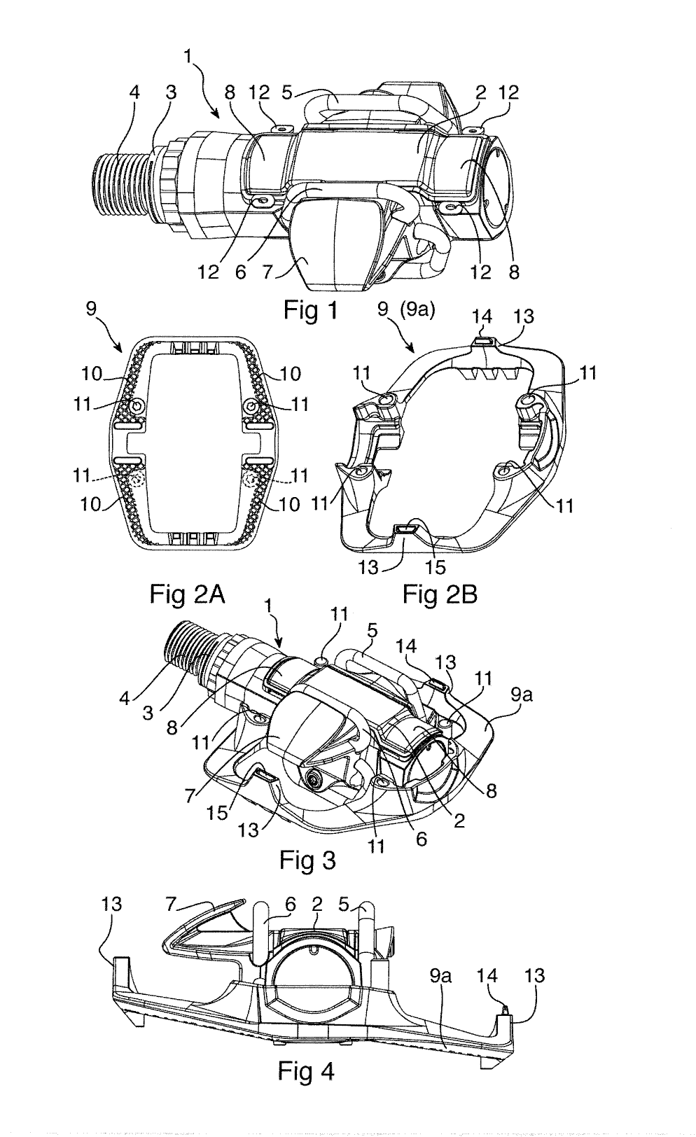

The pedal shown in FIG. 1 is a double-sided automatic pedal 1, that is to say a pedal with two opposing attachment faces suitable for receiving an attachment member fixed under the sole of a shoe of a cyclist (not represented). The pedal comprises a pedal body 2 mounted to rotate on a pedal axis 3 comprising, at its free end, a threading 4 for it to be fastened to a crankset crankarm (not represented). The pedal body 2 is, for each attachment face, provided with a front member 5 for engaging the attachment member, and a movable rear member 6 for retaining said attachment member. These front 5 and rear 7 members are, in the example illustrated in FIGS. 1 and 3 to 11, formed by hoops made of metal wire.

A guiding member 7 in the form of an inclined plate is arranged immediately behind the rear member 6 to prevent the chock from being engaged on the rear member when attaching the chock. By virtue of the presence of this guiding member 7, the cyclist does not need to watch the exact position of the shoe to attach it to the automatic pedal.

The automatic pedal 1 comprises primary support surfaces 8 provided on the pedal body 2 to offer a support to the sole of the shoe. It should be noted that these primary support surfaces are relatively limited and that, to increase the total area of the support surfaces, a support cage 9 associated with a pedal body is, as already mentioned, known from EP1338501. This support cage 9 which is arranged around the pedal body 2 comprises auxiliary support surfaces 10 which are preferably profiled to increase the friction between the sole of the shoe and these auxiliary support surfaces.

FIGS. 2A and 2B show a support cage 9 according to the invention which, according to an essential feature of the invention, is removable. According to this first embodiment, the support cage is single-sided.

The support cage 9 comprises link means 11 which, according to a first variant, are capable of cooperating with link means 12 provided on the pedal body 2. The link means 11 comprise fixing holes and fixing screws that have to cooperate with fixing holes provided in the link means 12 of the pedal body which are in the form of tabs.

The link means 11 and 12 make it possible to fix the support cage 9 to just one of the two opposing attachment faces of the pedal so that the other face of the pedal is free of auxiliary support surfaces. The cyclist thus has the choice of using or not using the support cage. He or she can also choose to entirely remove the support cage 9 to obtain an ordinary automatic pedal with no support cage.

The removable cage according to the invention comprises, according to a second variant of the first embodiment, a first part 9a and a second part 9b that are formed by a respective single-sided support cage and linked to one another by the link means 11. In this way, the automatic pedal has auxiliary support surfaces on two opposing attachment faces (see FIGS. 3 to 6). The pedal body 2, in this second variant, does not have the fixing tabs 12 belonging to the first variant.

The first and second parts are advantageously identical. They preferably comprise secondary link means comprising two opposite protuberances 13 provided in the middle of respective transversal sections of the first and second parts 9a, 9b of the support cage. These protuberances abut against one another when the first and the second parts 9a, 9b are assembled. In order to improve the link between two facing protuberances, one is provided with a tongue 14 which is inserted into a complementary void 15 provided in the other protuberance.

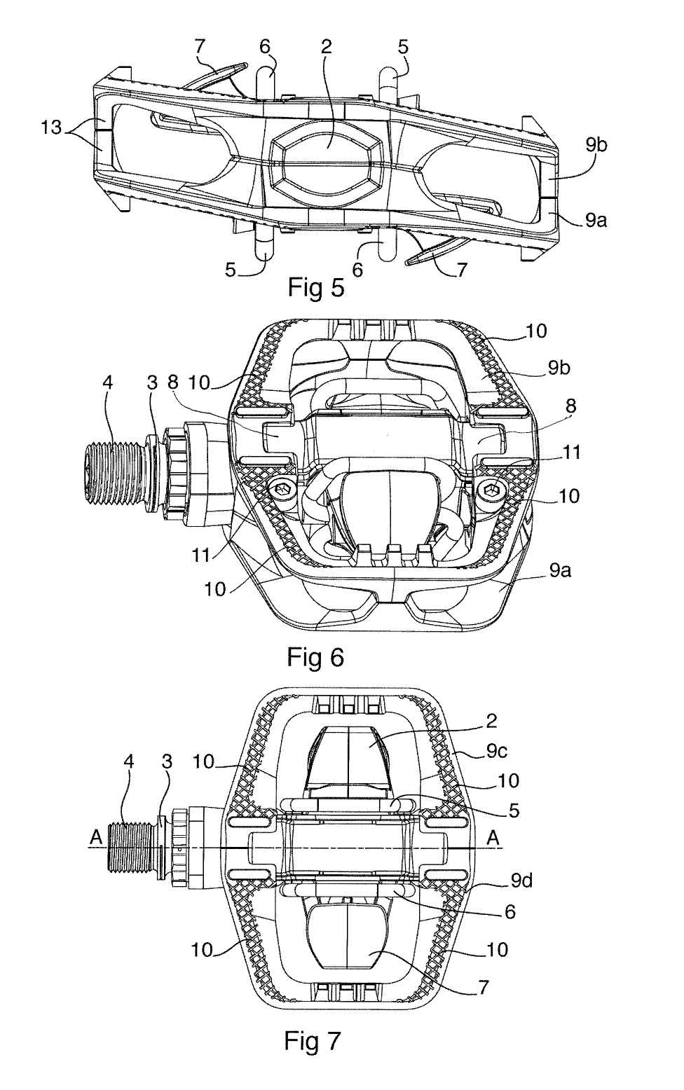

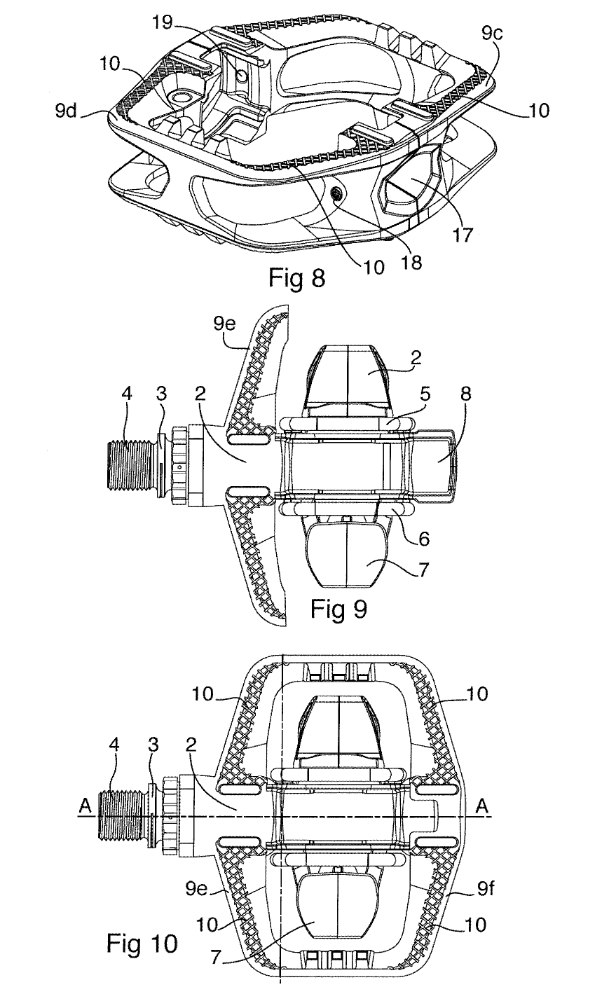

FIGS. 7 and 8 show a second embodiment in which the first 9c and second 9d parts of the support cage are double-sided and complementary to one another. Unlike the embodiment illustrated in FIG. 5, the first 9c and second 9d parts of the support cage are arranged symmetrically in front of and behind the pedal body. They respectively comprise a complementary lateral void 17 which together form a housing for receiving the pedal body 2 when said first and second parts 9c, 9d of the support cage are linked to one another along a joining plane passing through the central axis of the pedal axis. The first 9c and second 9d parts of the support cage are linked to one another using link means 18, as well as to the pedal body 2 by link means 19.

FIGS. 9 and 10 show a third embodiment in which the first 9e and second 9f parts of the support cage are double-sided. However, unlike the embodiments described previously, the first part 9a of said support cage is in the form of wings permanently linked to the pedal body 2 on an internal side thereof. The second part 9f is complementary to the first part 9e and is linked thereto along a joining plane at right angles to the central axis A-A of the pedal axis 3, whereas the second part 9f comprises a central hole similar to the voids 17 of the second embodiment. This central hole forms a housing for receiving the pedal body 2. In this way, the second part 9f which constitutes the larger part of the support cage can be slid through the side of the automatic pedal to be joined to the first part 9e.

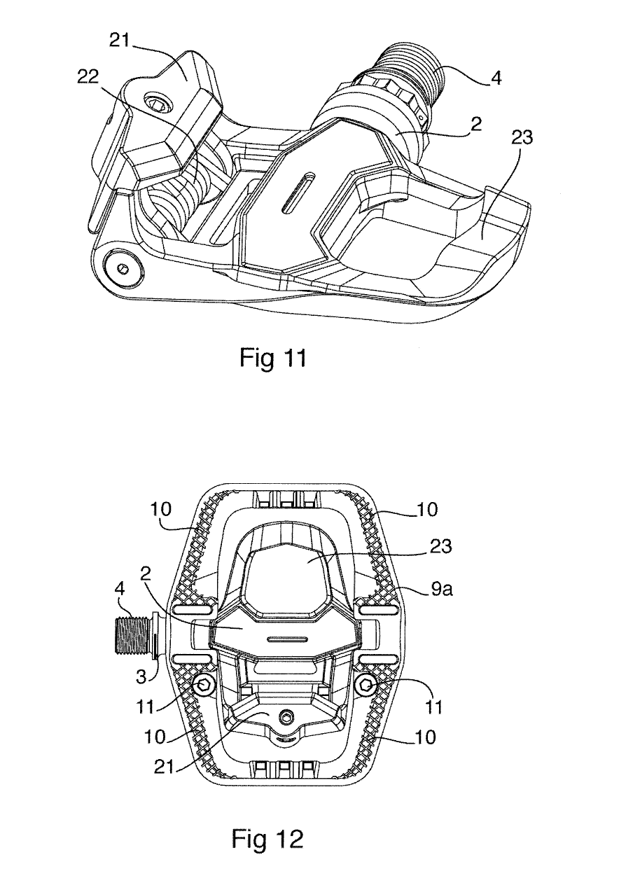

Finally, FIGS. 11 and 12 show another type of automatic pedal 20 with single attachment face in which the mobile rear member for retaining the chock consists of a lever 21 prestressed by a helical spring 22 toward a chock retaining position. A fixed front member 23 for engaging the chock is provided close to the front end of the pedal. This pedal is widely known, among other publications from EP1170203 from the applicant, and will not be described in more detail here.

This automatic pedal 20 is provided with a support cage 9 similar to that illustrated in FIG. 5, that is to say a support cage consisting of a first and a second part that are similar and single-sided 9a and which are linked to one another using link means 11 so as to sandwich the pedal body 2.

Obviously, the invention is not limited to the examples illustrated and described, and a very large number of variants can be envisaged by the person skilled in the art without in any way departing from the framework of the invention.

1. An automatic cycle pedal with support cage, comprising a pedal body mounted to rotate on a pedal axis, said pedal body being provided with a front member that can engage an attachment member fixed under the sole of a shoe of a cyclist, and a rear member that can retain said attachment member, the automatic pedal also comprising primary support surfaces provided on the pedal body and intended to be used simultaneously with auxiliary support surfaces provided on a support cage arranged around the pedal body while giving access to said front and rear members of the pedal body, wherein said support cage is mounted removably on the pedal body so as to allow the automatic pedal with support cage with auxiliary support surfaces to be converted into an ordinary automatic pedal without support cage with auxiliary support surfaces and vice versa.

2. The automatic cycle pedal as claimed in claim 1, wherein the support cage is of a single-sided single piece arranged on one of the attachment faces of the pedal, the pedal body comprising link means capable of cooperating with link means provided on the support cage, and in that the other attachment face of the pedal is free of auxiliary support surfaces.

3. The automatic cycle pedal as claimed in claim 1, wherein the support cage is formed by a first part and a second part provided with said auxiliary support surfaces and comprising link means making it possible to link them to one another so as to present auxiliary support surfaces on two opposing attachment faces of the automatic pedal.

4. The automatic cycle pedal as claimed in claim 3, wherein said first part and said second part of the support cage are single-sided and linked to one another so as to sandwich the pedal body.

5. The automatic cycle pedal as claimed in claim 3, wherein said first part and said second part of the support cage are double-sided and complementary to one another by being arranged symmetrically in front of and behind the pedal body, said first and second parts respectively comprising a lateral complementary void defining a housing for receiving the pedal body when said first and second parts of the support cage are linked to one another along a joining plane passing through the central axis of the pedal axis.

6. The automatic cycle pedal as claimed in claim 3, wherein said first part and said second part of the support cage are double-sided, in that said first part of said support cage is permanently linked to the pedal body on an internal side thereof, in that said second part is complementary to said first part and linked thereto along a joining plane at right angles to the central axis of the axis of the pedal, and in that said second part comprises a central through-hole defining a housing for receiving the pedal body.

7. A removable support cage with auxiliary support surfaces for an automatic cycle pedal as claimed in claim 2.

8. A set of removable support cages with auxiliary support surfaces for an automatic cycle pedal comprising a number of support cages corresponding to claim 7.

9. A removable support cage with auxiliary support surfaces for an automatic cycle pedal as claimed in claim 3.

10. A removable support cage with auxiliary support surfaces for an automatic cycle pedal as claimed in claim 4.

11. A removable support cage with auxiliary support surfaces for an automatic cycle pedal as claimed in claim 5.
